(19) United States
(12) Patent Application Publication
(10) Pub. No.: US 2009/0149195 A1
(43) Pub. Date: Jun. 11, 2009

(54) METHOD AND APPARATUS FOR PROVIDING ACCESS POINT WITH AREA IDENTITIES

(76) Inventor: Wei Zhu, Shenzhen (CN)

Correspondence Address: BRINKS HOFER GILSON & LIONE, P.O. BOX 10395, CHICAGO, IL, 60610, US

(21) Appl. No.: 12/353,681

(22) Filed: Jan. 14, 2009

Related U.S. Application Data
(63) Continuation of application No. PCT/CN2007/001552, filed on May 14, 2007.

(30) Foreign Application Priority Data
Jul. 14, 2006 (CN) 200610061669.7

(51) Int. Cl. H04W 8/00; H04W 4/00

(52) U.S. Cl. 455/456.1; 455/422.1

(57) ABSTRACT

The present invention provides a method for providing an access point in a UMTS with adequate area identities. The mobile communication system includes at least an AG and a plurality of APs connected to the AG. The method includes the following steps. A plurality of first area identities and at least one second area identity are configured on the AG. The APs communicate with a UE by using the first area identities. The first area identities are converted into the second area identity. Finally, the AG communicates with a core network by using the second area identity. A corresponding system is also provided. Thus, unnecessary operations that an unauthorized user attempts to access an AP repeatedly is prevented, and a situation that an authorized user is unable to access an own access point after being rejected by other APs is completely prevented. The configured area identities are used by only the UE and APs, have no influence on the performance of the core network, and may reduce configuration requirements for the core network.

The application claims the benefit of priority to Chinese Patent Application No. 200610061669.7, filed on Jul. 14, 2006, and entitled “METHOD FOR PROVIDING AN ACCESS POINT WITH AREA IDENTIFIERS AND THE SYSTEM THEREOF”, which is incorporated herein by reference in its entirety.

### BACKGROUND OF THE INVENTION

1. Field of the Invention

The present invention relates to the technical field of mobile telecommunication, and more particularly, to an access technology in a universal mobile telecommunications system.

2. Background of the Invention

Universal mobile telecommunications system (UMTS) is a third generation mobile communication system using the wideband code division multiple access (WCDMA) air interface technology. The UMTS has a network system structure as shown in FIG. 1, which includes a user equipment (UE), a universal terrestrial radio access network (UTRAN) and a core network (CN). The UTRAN is adapted to process all radio-related functions, and includes one or more radio network subsystems (RNSs) each composing of a radio network controller (RNC) and one or more base stations (Node B). The CN is adapted to process all voice calls and data connection in the UMTS, and to implement exchange and routing functions with an external network. The CN includes a gateway mobile switching center (GMSC), a gateway GPRS support node (GGSN), a serving GPRS support node (SGSN), a home location register (HLR), a visitor location register/mobile switching center (VLR/MSC), and the like.

With the progress of Internet services and extensive applications of the broadband access network and wireless network, the fast and convenient UTRAN becomes more and more popular. Meanwhile, to better utilize the existing network resources and save the cost of network equipment operators, a UMTS access point-gateway (AP-AG) equipment is introduced into the existing mobile network, in which a Gi interface is configured on the AP for the direct access to the Internet, and the impact of high speed data (HSD) service on the mobile network is greatly reduced, so that more HSD users may access the existing wireless network. The introduction of the AP also breaks through the bottleneck of air interface resources in the wireless data service, and divides the HSD service users in a macro-cell.

FIG. 2 is a schematic view of the topological structure of a UMTS network after the UMTS AP-AG equipment is introduced, in which GMSC, GGSN, and SGSN are respectively a gateway mobile switching center, gateway GPRS support node, and serving GPRS support node in the UMTS core network, RNC is a radio network controller, MS is a mobile station, HLR is a home location register, VLR/MSC is a mobile switching center integrating a visitor location register, EIR is an equipment identity register, CGF is a charging gateway function module. The UMTS AP is a private equipment of a user, and thus an admission control mechanism needs to be realized on the AP-AG equipment, that is, only the access of an authorized user is accepted while the residence of an unauthorized user is rejected. The AP adopts a location area update (LAU) reject or routing area update (RAU) reject message to prevent the unauthorized user from residing in the AP cell. After receiving the reject message, the UE temporarily prohibits the location area identity (LAI) of the AP for, for example, 12-24 hours, or cancels the prohibition after the subscriber powers off, thus preventing repeated attempts to access the AP cell of the unauthorized user.

The LAI is adapted to identify the location area of the user. Ideally, each AP cell has a different LAI. Thus, the problem that an AP user cannot use his/her own AP normally in a short term after the AP user is rejected by another AP using the same LAI is prevented.

If a large number of AP users reside in an area, and each AP using a different LAI cannot be realized, the number of APs using the same LAI should not be too great, so as to reduce the probability that the user accesses the APs using the same LAI. Currently, two solutions are provided.

In one solution of the prior art, a plurality of APs in an area use the same LAI, and the LAI used by the APs is independent from an LAI used for macro coverage. This data configuration method has no adverse effect for authorized users of the APs. However, an AP will reject the access of unauthorized uses. If the reject message does not prohibit the LAI, the UE will repeatedly attempt to access this AP, which increases the signaling load of the AP, or even affects the normal usage of other authorized users. If the reject message prohibits the LAI, as the LAI is used by multiple APs, the UE cannot access any one of the APs after the LAI is prohibits. If the AP of the user also uses this LAI, when the user is switched to another AP cell, the user cannot use his/her own AP because the UE does not initiate the cell reselection due to the prohibition of the LAI, and thus the user has to power off (to delete the LAI prohibition list) and then power on to access his/her own AP normally.

In the other solution of the prior art, many LAIs (for example, 10000 LAIs) are assigned to the APs in an area, so that the number of APs using the same LAI is reduced, which lowers the probability that the LAI used by the AP of the user is prohibited.

However, so many LAIs cause a significantly increased workload on core network configuration for the operators. When the LAI configuration of the APs is changed, the corresponding configuration data of the core network needs to also be modified, which greatly increases the human cost of the operators. Moreover, the configured LAIs have influences on the whole network. If the APs in different areas use the same LAIs (the number of LAIs is limited, and the LAIs need to be used repeatedly), unexpected influences on the core network may occur.

### SUMMARY OF THE INVENTION

The present invention is directed to a method and a system for providing adequate LAIs/routing area identities (RAIs) in a UMTS, so as to avoid unnecessary operations that an unauthorized user attempts to access an AP repeatedly, avoid that an authorized user is unable to access an own AP after being rejected by another AP, and lower configuration requirements of a core network.

In an embodiment of the present invention, a method for providing an access point (AP) in a mobile telecommunication system with area identities includes: communicating, by the APs, with a user equipment (UE) by using first area identities; performing conversion between the first area identities and a second area identity; and communicating, by a access gateway (AG), with a core network by using the second area identity.

In an embodiment of the present invention, an AP in a mobile telecommunication system includes: a first area identity converting unit, adapted to perform conversion between a first area identity for communicating with a UE and a second area identity for communicating with a core network.

In an embodiment of the present invention, an AG in a mobile telecommunication system includes: a second area identity converting unit, adapted to perform conversion between a first area identity for communicating with a UE and a second area identity for communicating with a core network.

In an embodiment of the present invention, a system for providing an AP in a mobile telecommunication system with area identities includes: an access network subsystem comprising at least one AG and a plurality of APs connected to the AG, where at least one of the APs or the AG is configured with an area identity converting unit, adapted to perform conversion between a first area identity for communicating with a UE and a second area identity for communicating with a core network.

After utilizing the method and system provided in the present invention, in a city having a small number of APs, it is possible for each AP to have a unique LAI/RAI. When the access of an unauthorized user is rejected, the corresponding LAI/RAI may be prohibited to prevent the user from attempting to access repeatedly. In addition, the problem that a user is unable to access his/her own AP after being rejected by another AP is completely prevented because each AP has a unique LAI/RAI. Even if the number of the APs is very great, the probability of this problem is reduced as much as possible.

Further, the LAI/RAI configured in the embodiment of the present invention is only used by the UE and APs, and has no influence on the core network. Therefore, the core network does not need to have additionally data configuration, and no additional human cost will be generated for operators.

### BRIEF DESCRIPTION OF THE DRAWINGS

The present invention will become more fully understood from the detailed description given as follows for illustration only, which is not limitative to the present invention, and in which:

FIG. 1 is a structural view of the construction of a UMTS;

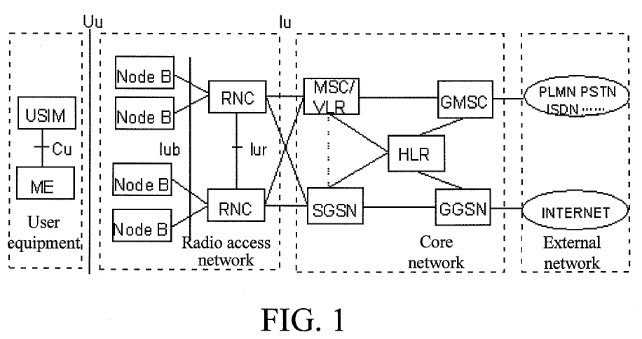

FIG. 2 is a topology view of a conventional UMTS network having the AP-AG system;

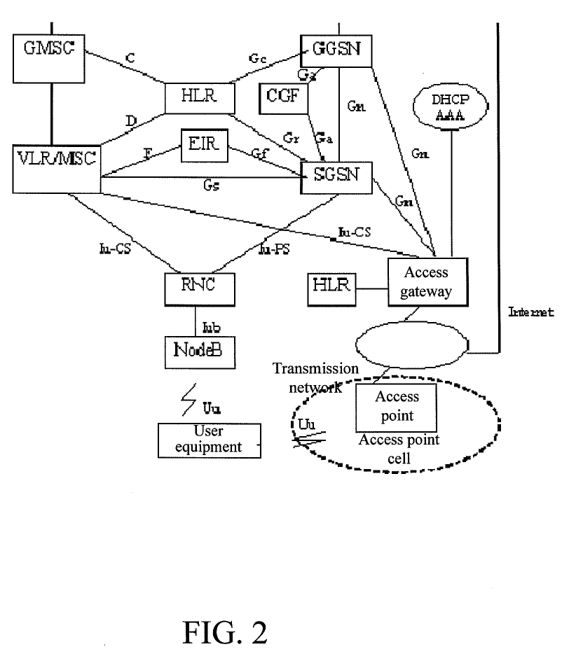

FIG. 3 is a timing diagram of message and signaling transmission between the UE, AP, AG, and mobile switching center when a UE performs location update according to an embodiment of the present invention;

FIG. 4 is a timing diagram of message and signaling transmission between the UE, AP, AG, and mobile switching center when a UE performs location update according to another embodiment of the present invention;

FIG. 5 is a block diagram of a system for providing an AP in a UMTS with adequate area identities according to an embodiment of the present invention; and

FIG. 6 is a block diagram of a system for providing an AP in a UMTS with adequate area identities according to another embodiment of the present invention.

### DETAILED DESCRIPTION OF THE EMBODIMENTS

Details in some circumstances are described in the following to provide a comprehensive understanding of the present invention.

A method for providing an AP in a UMTS with adequate LAI/RAI according to an embodiment of the present invention is based on an access system. The access system includes a plurality of AGs and a plurality of APs each connecting to an AG. Each AG is configured with one or more static LAIs according to the number of APs connected thereto, the LAI is provided for the communication between the AG and a core network, and is referred to as a land LAI hereinafter. Each AP dynamically obtains an LAI from the AG connected thereto, the LAI is provided for the communication between the AP and a UE, and is referred to as an air interface LAI hereinafter.

The UE receives information of the air interface LAI from a broadcast channel, and performs cell reselection and location area update according to the air interface LAI information. The land LAI appears in the IUP and uplink interfaces, the mobile switching center and the serving GPRS support node can only view the land LAI, and all NAS process and data configuration are performed according to the land LAI.

The LAI/RAI carried in the message received/sent by the UE is the air interface LAI/RAI, and the LAI/RAI carried in the message received/sent by the AG and core network is the land LAI/RAI. Therefore, the method for providing an AP in a UMTS with adequate LAIs/RAIs according to the present invention should realize the conversion between two LAIs/RAIs. In an embodiment of the present invention, the conversion includes, for example, converting the air interface LAI/RAI information carried in an uplink message into the land LAI/RAI, which is provided to the core network for processing a corresponding request of the UE, and converting the land LAI/RAI carried in a downlink message into the air interface LAI/RAI, so as to record the updated LAI/RAI into the UE. The conversion may be completed in the AP or the AG. Except for the AP or the AG, other network element equipment may be compatible to the standard protocols by only processing one LAI/RAI.

The above “conversion” process may be realized through four implementations as follows:

the AP performs the conversion between the air interface LAI and the land LAI;

(2) the AP performs the conversion between the air interface RAI and the land RAI;

(3) the AG performs the conversion between the air interface LAI and the land LAI; and

(4) the AG performs the conversion between the air interface RAI and the land RAI.

The method of performing conversion between the air interface LAI and the land LAI by using the AP is described in detail below through a preferred embodiment.

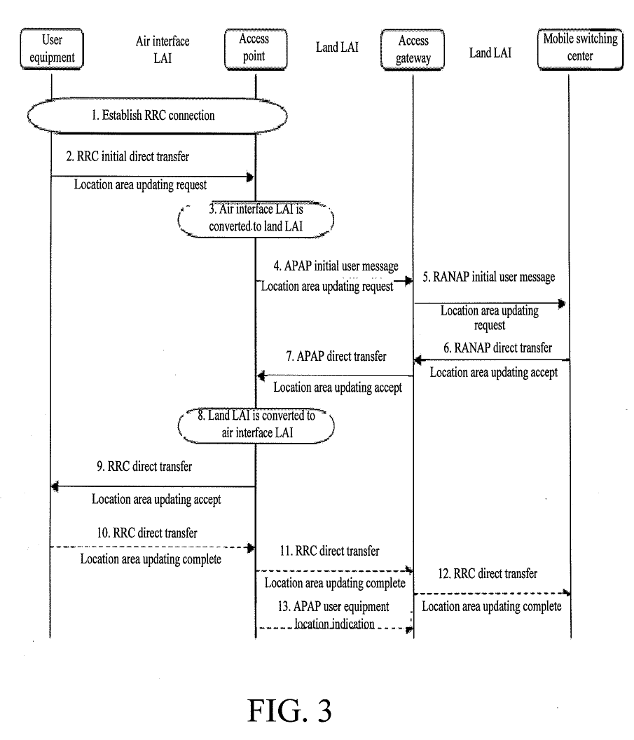

FIG. 3 is a timing diagram of message and signaling transmission between the UE, AP, AG; and mobile switching center when the UE performs location update. As shown in FIG. 3, the conversion between the air interface LAI and the land LAI is performed on the AP.

In Step 1, an access stratum (AS) of the UE in an idle mode requests to establish a signaling connection, and the UE initiates a radio resource control (RRC) connection request to the AP, so that the transmission of radio network signaling may be performed between the UE and a UTRAN.

In Step 2, when the LAI received by the UE is different from the LAI stored in the UE, the UE initiates a location area update request to the current AP, which includes the following three situations.

In the first situation, the UE accesses the AP cell from a macro cell, and initiates the location area update request in the AP cell for the first time. In this situation, the LAI carried in the update request message is the LAI of the macro cell, which does not need to be converted, and the process directly proceeds to Step 4.

In the second situation, the UE initiates the location update request periodically in the current AP cell, and at this time the LAI carried in the request message is the air interface LAI of this AP, which needs to be converted into the land LAI through the AP, that is, the process proceeds to Step 3.

In the third situation, the UE comes from another AP, and the update request message carries the air interface LAI of the other AP, which cannot be converted by this AP. This situation seldom occurs, and in this situation, the AP does not need to perform the conversion, and the mobile switching center may obtain data from a home location register (HLR) when the LAI cannot be recognized.

Although only three situations are mentioned in Step 2 of the method for providing an AP in a UMTS with adequate LAIs/RAIs according to the embodiment of the present invention, it should be noted that, in addition to the above three situations, the practicability of the solution of the present invention is not affected when the UE accesses the macro cell from the AP cell. In particular, if the UE accesses the macro cell from the AP cell it originally resides, the UE sends a location update or routing update request, and the air interface LAI carried in the request message is then sent to the mobile switching center. The mobile switching center is unable to recognize the air interface LAI to obtain the corresponding registration information, and thus initiates a request to the UE to obtain international mobile subscriber identity (IMSI) information, obtains the registration information from the HLR, and accepts the location area update request or routing area update request of the UE after the authentication is passed. It is understood that the two LAIs (the air interface LAI and the land LAI) configured on the AP have no influence on the macro cell, and thus when the UE accesses the macro cell from the AP cell, an access equipment of the macro cell does not need to convert the LAIs.

In Step 3, the AP converts the air interface LAI into the land LAI.

In Step 4, the AP modifies the LAI information contained in a direct transfer message into the land LAI, and sends the location area update request to the AG, and the AG, the mobile switching center, and the SSGN feel that the UE resides in the location area covered by the land LAI.

In Step 5, the AP directly transfers the location area update request (containing the land LAI information) to the mobile switching center through the Radio Access Network Application Part (RANAP) protocol of the air interface.

In Step 6, the mobile switching center directly transfers the location update accept message (containing the land LAI information) to the AG through the RANAP.

In Step 7, the AG downloads the location update accept message to the AP.

In Step 8, the AP converts the land LAI in the update accept message into the air interface LAI.

In Step 9, the AP delivers the location area update accept message to the UE, the LAIs in the location area update accept message are all the air interface LAI, and thus the UE feels that the UE has resided in the location area covered by the air interface LAI.

In Step 10, the UE reports to the AP that the location area update is completed.

In Step 11, the AP reports to the AG that the location area update is completed.

In Step 12, the AG reports to the mobile switching center that the location area update is completed.

In Step 13, the AP sends a UE location indication message to the AG.

In the above preferred embodiment, the LAI conversion in the UE location update is taken as an example to describe the present invention. In practice, in the NAS messages, the following messages include the LAI or RAI information, and the processes of the messages are similar to the above embodiment, which are analyzed one by one in the following.

Connection Management Re-Establishment Request (CM Re-Establishment Request)

This message is sent to the core network by the UE, and is initiated after the UE resides in the AP successfully. The air interface LAI of the AP is carried in this message, and thus the AP needs to convert the air interface LAI into the land LAI with a similar conversion process as described in the above preferred embodiment.

2) Location Update Request and Location Update Accept

The two messages carry the LAI information, and the conversion between the air interface LAI and the land LAI is needed. The conversion process has been described in the above preferred embodiment.

3) Temporary Mobile Subscriber Identity Reallocation Command (TMSI Reallocation Command) and Packet Temporary Mobile Subscriber Identity Reallocation Command (P-TMSI Reallocation Command)

The two messages are sent to the UE by the core network, and are initiated after the UE successfully obtains the TMSI/P-TMSI. The land LAI/RAI of the AP is carried in the messages, and thus the AP needs to convert the land LAI/RAI into the air interface LAI/RAI with a similar conversion process as described in the above preferred embodiment.

4) Attach Request and Attach Accept

This pair of messages is used when the UE initiates the attachment. The RAI is carried in the messages, and can be converted through a similar conversion process as described in the above preferred embodiment because the conversion of RAI is similar to the conversion of LAI.

5) Routing Area Update Request and Routing Area Update Accept

The RAI is composed of LAI+RAC (routing area code), and thus when the UE performs the routing area update, the process is substantially the same as the process of location area update, and may be understood by reference to the description of the above preferred embodiment.

It should be understood from the above analysis that it is completely feasible to perform conversion on the LAI and RAI information carried in the NAS messages by using the AP.

During network planning, the land LAI may be configured into the existing core network and may affect the existing network. The air interface LAI is used by only the UE and the AP, and may not affect the existing network. The allocation of the land LAI is not specified, and it is suggested that one AG is configured with at least one land LAI. As for the air interface LAI, to ensure that every AP has a unique air interface LAI. The operator should use additional PLMN (reserved and unused PLMN), which not only provides sufficient air interface LAIs, but also provides more convenient location indication after the user accesses the AP cell. If the operator can provide 3 PLMNs, the number of air interface LAIs available to the APs reaches 196608, which are enough for the APs of a whole city. If the operator is unable to apply for additional PLMN, the remaining LAIs in the existing PLMN may serve as virtual LAIs (air interface LAIs). If no additional PLMN is available, the virtual LAIs should be reused because it is impossible to allocate a unique air interface LAI for each AP. One PLMN has 65536 available LAIs, and generally a large operator uses several only thousands of them; therefore, sufficient air interface LAIs may be provided for the APs. Assume that the operator may provide 30000 LAIs, and the APs in the city reuse the 30000 LAIs. When the number of the APs exceeds 30000, the virtual LAIs may be repeated. When an AP user passes an AP having the same virtual LAI, if the UE of the user attempts to reside on this AP cell but is rejected, the UE prohibits the LAI. When the user is home, the UE does not initiate the cell reselection because the LAI is prohibited. Therefore, the user needs to power off and then power on the UE to reside on the AP normally. Generally, an AP has a very small signal range, and the probability of the above situation is quite small when there are 30000 available LAIs. Therefore, if the operator is unable to apply for an additional PLMN, the above solution is feasible with a tiny possibility that the user has to power off and then power on the UE.

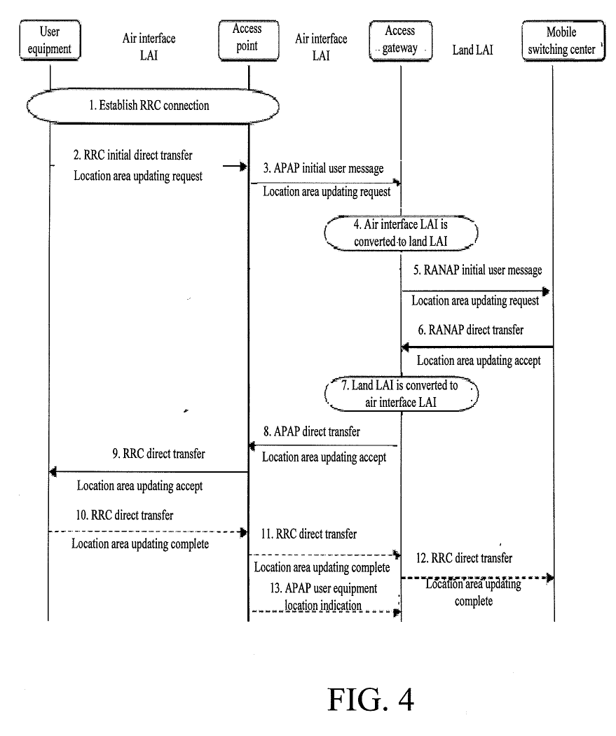

The conversion between the air interface LAI and the land LAI may also be realized by the AG, which is similar to the conversion by the AP. In an embodiment of the present invention, the location update request is still taken as an example to describe the conversion described with reference to FIG. 4.

After the AP receives an uplink location update request, the AP forwards the message to the AG, the AG converts the LAI-air carried in the location update request message into the LAI-land according to a recorded LAI conversion table, and then forwards the message to the mobile switching center. When the AG receives a location update accept from the mobile switching center, the AG converts the LAI-land in the message into the LAI-air, and sends the message to the AP, and the AP then forwards the message to the UE.

The messages that need to be converted are the same as those in the above embodiment realized by the AP, which are not described again here.

A table needs to be maintained in the AG because one AG manages a plurality of APs. The table records and manages the LAI-air and LAI-land corresponding to each AP, and an example of the table is as follows:

| | | |
|---|---|---|
| AP1 | LAI-air1 | LAI-land1 |
| AP2 | LAI-air2 | LAI-land1 |
| AP3 | LAI-air3 | LAI-land2 |
| AP4 | LAI-air4 | LAI-land1 |
| . . . | . . . | . . . |

When performing the conversion, the AG looks up the table to find the LAI relationship according to the AP, so as to complete the conversion of LAI.

The planning of network parameters is the same as that in the method of realizing LAI conversion with the AP, which is not described again here.

To simplify the description, the LAI and the RAI may be referred to as area identities.

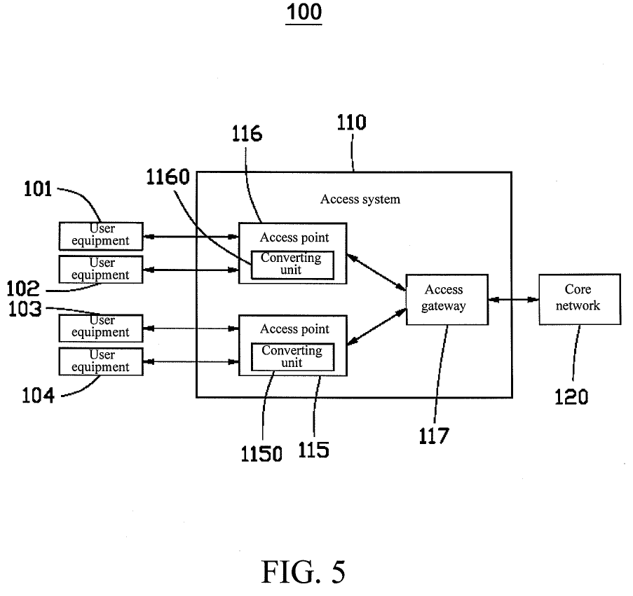

The above method of the present invention is implemented based on a system, that is, a system for providing a UMTS system with adequate area identities. FIG. 5 shows a system 100 for providing a UMTS system with adequate area identities according to a first embodiment of the present invention. Referring to FIG. 5, the system 100 includes several UEs 101, 102, 103, 104, at least one access system 110, and a core network 120. The access system 110 is connected between the UEs 101-104 and the core network 120, and includes a plurality of APs 115, 116, and an AG 117. When one of the UEs 101-104 intends to access the corresponding AP 115 or 116, the UE communicates with the AP 115 or 116 by using the first area identity. The AP 115 or 116 is provided with an area identity converting unit 1150 or 1160 respectively, which is adapted to convert a first area identity contained in the area update request message received from the UE into a second area identity. The request message containing the second area identity is transmitted to the AG 117, and the AG communicates with the core network 120 by using the second area identity. In contrast, after the AP 115 or 116 receives a location update acknowledge message from the core network 120, the converting unit 1150 or 1160 thereof converts the second area identity in the acknowledge message into a plurality of first area identities. Different UEs 101-104 use different first area identities, and the different first area identities may be converted into the same second area identity through the converting units 1150, 1160.

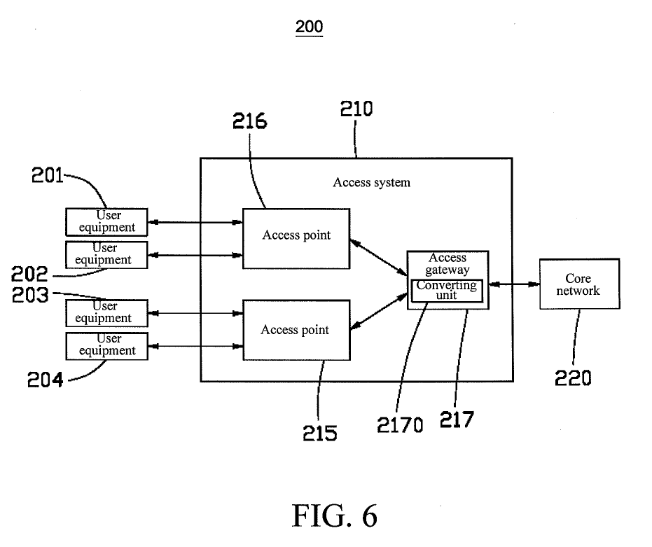

FIG. 6 shows a system 200 for providing a UMTS system with adequate area identities according to a second embodiment of the present invention. The system 200 includes several UEs 201, 202, 203, 204, at least one access system 210, and a core network 220. The access system 210 is connected between the UEs 201-204 and the core network 220, and includes a plurality of APs 215, 216, and an AG 217. When one of the UEs 201-204 intends to access the corresponding AP 215 or 216, the UE communicates with the AP 215 or 216 by using a first area identity. The AG 217 is provided with an area identity converting unit 2170, which is adapted to convert the first area identities contained in the area update request messages received from the APs 215, 216 into a second area identity. The AG 217 communicates with the core network 220 by using the second area identity. In contrast, after the AG 217 receives a location update acknowledge message from the core network 120, the converting unit 2170 of the AG 217 converts the second area identity contained in the acknowledge message into a plurality of first area identities for the APs 215, 216 to use.

Compared with the prior art, with the method and system for providing a UMTS system with adequate area identities according to embodiments of the present invention, for a city having a small number of APs, it is possible for each AP to have a unique area identity. When the access of an unauthorized user is rejected, the corresponding area identity may be prohibited to prevent the user from attempting to access repeatedly. In addition, each AP has a unique area identity, and the situation that an authorized user is unable to access his/her own AP after being rejected by another AP is completely prevented. Even if the number of the APs is very great, the possibility that this situation occurs may be reduced to the minimum. Further, the area identities configured in the present invention are used only by the UE and the APs, which has no influence on the core network. Therefore, the core network does not need to configure additional data, thus saving additional human cost for the operator.

Although the invention has been described through some exemplary embodiments, the invention is not limited to such embodiments. It is apparent that those skilled in the art can make various modifications and variations to the invention without departing from the scope of the invention. The invention is intended to cover the modifications and variations provided that they fall into the scope of protection defined by the appended claims and their equivalents.

What is claimed is:

1. A method for providing an access point (AP) in a mobile telecommunication system with area identities, comprising:
communicating, by the APs, with a user equipment (UE) by using first area identities;
performing conversion between the first area identities and a second area identity; and
communicating, by an access gateway_(AG), with a core network by using the second area identity.

2. The method according to claim 1, further comprising:
configuring a plurality of the first area identities and at least one second area identity on the AP or the AG.

3. The method according to claim 1, wherein the area identities are location area identities (LAIs) or routing area identities (RAIs).

4. The method according to claim 1, wherein in the communicating, by the AP, with the UE by using the first area identities, each AP dynamically obtains one first area identity from the AG connected thereto.

5. The method according to claim 1, wherein the conversion from the first area identities into the second area identity performed by an access system is implemented by one of the APs or the AG.

6. The method according to claim 1, wherein
the communicating, by the APs, with the UE by using the first area identities comprises: receiving, by the AP, an uplink message comprising the first area identity from the UE, and forwarding, by the AP, a downlink message comprising the first area identity to the UE; and
the communicating, by the AG, with the core network by using the second area identity comprises: receiving, by the AG, a downlink message comprising the second area identity from the core network, and forwarding, by the AG, an uplink message comprising the second area identity to the core network.

7. The method according to claim 1, wherein the first area identity is carried in an area update request, and the method further comprises:
receiving, by the AP, the area update request from the UE, forwarding the request to the AG, converting, by the AG, the first area identity carried in the request into the second area identity, and sending the request to the core network; and
wherein the second area identity is carried in an acknowledge message and the method further comprises;
receiving, by the AG, the acknowledge message in response to the area update request from the core network, converting the second area identity carried in the acknowledge message into the first area identity, forwarding the message to the AP, and sending, by the AP, the acknowledge message to the UE.

8. The method according to claim 7, wherein the area update request is one of a location area update request or a routing area update request.

9. An access point (AP) in a mobile telecommunication system, comprising:
a first area identity converting unit, adapted to perform conversion between a first area identity for communicating with a user equipment (UE) and a second area identity for communicating with a core network.

10. The AP according to claim 9, wherein the AP is configured with a plurality of the first area identities, and at least one of the second area identities.

11. An access gateway (AG) in a mobile telecommunication system, comprising:
a second area identity converting unit, adapted to perform conversion between a first area identity for communicating with a user equipment (UE) and a second area identity for communicating with a core network.

12. The AG according to claim 11, wherein the AG is configured with a plurality of the first area identities, and at least one of the second area identities.

13. A system for providing an access point (AP) in a mobile telecommunication system with area identities, comprising:
an access network subsystem comprising at least one access gateway (AG) and a plurality of APs connected to the AG, wherein
at least one of the APs or the AG is configured with an area identity converting unit adapted to perform conversion between a first area identity for communicating with a user equipment (UE) and a second area identity for communicating with a core network.

14. The system according to claim 13, wherein the area identity converting unit is included in the APs or the AG.

15. The system according to claim 13, wherein the AG is configured with at least one second area identity for the AG to communicate with a core network, and a plurality of first area identities for the APs to communicate with the UE.
